(19) United States
(12) Patent Application Publication
(10) Pub. No.: US 2012/0109890 A1
(43) Pub. Date: May 3, 2012

(54) METHOD AND APPARATUS FOR REGISTERING SNS INFORMATION

(75) Inventors: Young Min LEE, Gyeongsangbuk-do (KR); Chan LEE, Gyeongsangbuk-do (KR)

(73) Assignee: SAMSUNG ELECTRONICS CO., LTD., Gyeonggi-Do (KR)

(21) Appl. No.: 13/285,447

(22) Filed: Oct. 31, 2011

(30) Foreign Application Priority Data
Oct. 29, 2010 (KR) 10-2010-0106623

(51) Int. Cl. G06F 7/00

(52) U.S. Cl. 707/617; 707/E17.032; 707/E17.014

(57) ABSTRACT

The present invention provides a method and an apparatus for registering Social Networking Service (SNS) information using phone book data. The method includes checking whether or not phone book data includes at least one SNS information; and registering the at least one SNS information in an SNS address book of user, when the phone book data includes the at least one SNS information.

### CLAIM OF PRIORITY

This application claims priority under 35 U.S.C. §119 from Korean Patent Application No. 10-2010-0106623, filed Oct. 29, 2010, the contents of which are hereby incorporated by reference in its entirety.

### BACKGROUND OF THE INVENTION

1. Field of the Invention

The present invention relates to a method and an apparatus for registering Social Network Service (SNS) information. More particularly, the present invention relates to a method and an apparatus for registering SNS information using phone book data of a portable communication terminal.

2. Description of the Related Art

Recently, due to the development of an information and communication technology and a semi-conductor technology, various types of mobile terminals have rapidly spread and become widely used. In particular, recent mobile terminals accomplish a mobile convergence stage which puts together the area of other terminals beyond its own traditional area. Typically, in case of the mobile telecommunication terminal, in addition to general telecommunication functions such as voice communication and a short message service (SMS), various multimedia functions such as a TV function (e.g., a mobile broadcasting like a Digital Multimedia Broadcasting (DMB) and a Digital Video Broadcasting (DVB)), a music play function (e.g., MPEG Audio Layer-3 (MP3), a camera function, an Internet access function, and a dictionary search function are added.

Moreover, with the ongoing development of wireless Internet technology, increasing attention has been focused recently on a social network service (SNS) such as Twitter, Facebook, or the like. Accordingly, the number of users accessing SNS through the mobile terminal continues to increase. In order to use SNS, the SNS information (e.g., ID) of the opponent (hereinafter referred to as “recipient party”) has to be registered in its own SNS address book. However, conventionally, the user has to manually add the SNS information of the recipient party in its own SNS address book. In other words, conventionally, the user has to ask the recipient party the SNS information (e.g., ID) or search the SNS information of the recipient party through a SNS program, and has to register the recipient party in its own SNS address book.

### SUMMARY OF THE INVENTION

The present invention provides a method and an apparatus for registering SNS information which can automatically and easily register SNS information by linking a phone book function with a SNS function of a mobile terminal.

The present invention further provides a method and an apparatus for registering SNS information which can search information of the recipient party using information (name, phone number, e-mail, or the like.) stored in a phone book and automatically register the SNS information in a SNS address book and a phone book of user.

The present invention further provides a method and apparatus for registering SNS information which can automatically register SNS information included in a phone book data in a SNS address book when receiving the phone book data including the SNS information from the recipient party.

In accordance with an exemplary aspect of the present invention, a method of registering SNS information, preferably includes: checking whether phone book data includes at least one SNS information; and registering the at least one SNS information in a SNS address book of user, when the phone book data includes the at least one SNS information.

In accordance with another exemplary aspect of the present invention, a method of registering SNS information preferably includes: a storage unit configured to store at least one phone book data; and a controller configured to check whether the phone book data includes at least one SNS information, and register at least one SNS information in a SNS address book of user when the phone book data includes the at least one SNS information.

As illustrated in the above, according to the present invention, a method and an apparatus for registering SNS information can easily register SNS information of the recipient party by linking a phone book function with a SNS function.

In addition, the present invention can search information of a corresponding opponent using information like name, phone number, e-mail, or the like stored in a phone book. In other words, even though the user does not access to the web server providing SNS, the user can search and register the SNS information of the recipient party.

Accordingly, the present invention can improve the convenience of user when using the SNS through the mobile terminal.

### BRIEF DESCRIPTION OF THE DRAWINGS

The exemplary objects, features and advantages of the present invention will become more apparent to a person of ordinary skill in the art from the following detailed description in conjunction with the accompanying drawings, in which:

FIG. 1 is a block diagram illustrating a configuration of a mobile terminal according to an exemplary embodiment of the present invention;

FIG. 2 is a flowchart illustrating an operational example of a method of registering SNS information using an address book transmission function according to a first exemplary embodiment of the present invention;

FIG. 3 is a flowchart illustrating an operational example of a method of registering SNS information using a phone book according to a second exemplary embodiment of the present invention; and

FIGS. 4 to 5 are examples of screens that illustrate a method of registering SNS information using a phone book according to a second exemplary embodiment of the present invention.

### DETAILED DESCRIPTION

Exemplary embodiments of the present invention are described with reference to the accompanying drawings in detail. The same reference numbers are typically used throughout the drawings to refer to the same or like parts. Detailed descriptions of well-known functions and structures incorporated herein may be omitted to avoid obscuring appreciation of the subject matter of the present invention by a person of ordinary skill in the art.

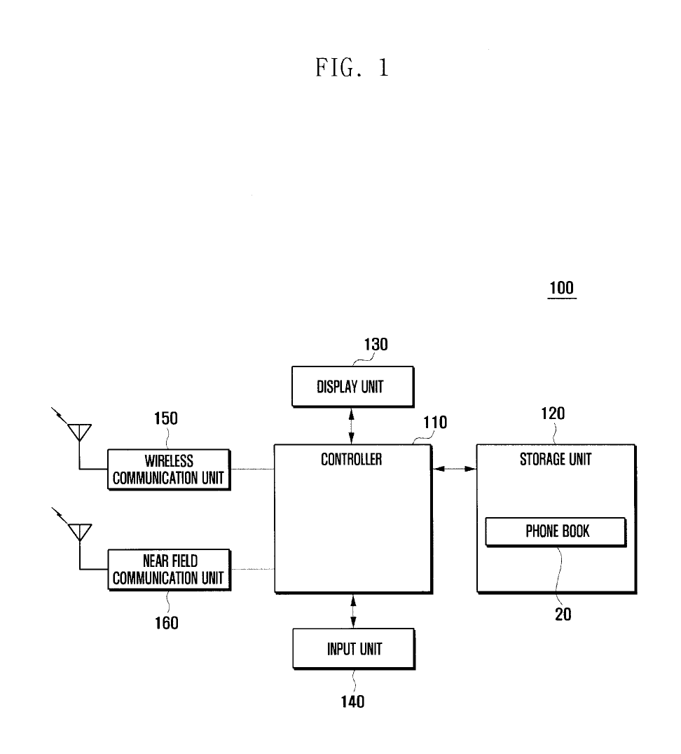

FIG. 1 is a block diagram illustrating a configuration of a mobile terminal according to an exemplary embodiment of the present invention.

Referring now to FIG. 1, the mobile terminal 100 according to an exemplary embodiment of the present invention preferably includes a controller 110, a storage unit 120, a display unit 130, an input unit 140, a wireless communication unit 150, and a near field communication unit 160.

The input unit 140 transmits an input signal containing various number and text information, and an input signal inputted in association with the setting and control of each functions of the mobile terminal 100 to the controller 110. To this end, the input unit 140 preferably includes input keys for inputting number and character information, and function keys for setting each function or controlling each function of the mobile terminal 100. The function keys may include, for example, a direction key, a side key and a shortcut key which are set for performing a specific function. For example, the input unit 140 preferably includes a send key for requesting a call, a call termination key, and a hold key. Particularly, according to an exemplary embodiment of the present invention, the input unit 140 can transmit an input signal requesting registration of the SNS information which is included in the phone book data (address book), and an input signal requesting search of the SNS information of a corresponding recipient party using the information (e.g., name, e-mail address, phone number, or the like.) included in the phone book data to the controller 110. According to providing type of the mobile terminal 100, the input unit 140 can be formed with one or more combinations, such as from among a touch pad, a touch-screen, a keypad having a general key arrangement and a keypad preferably having a QWERTY type.

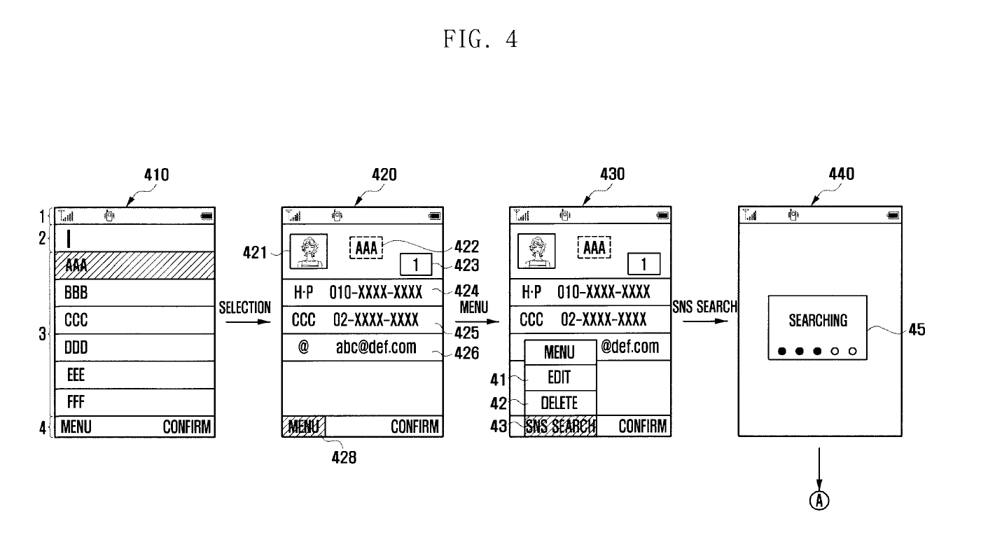

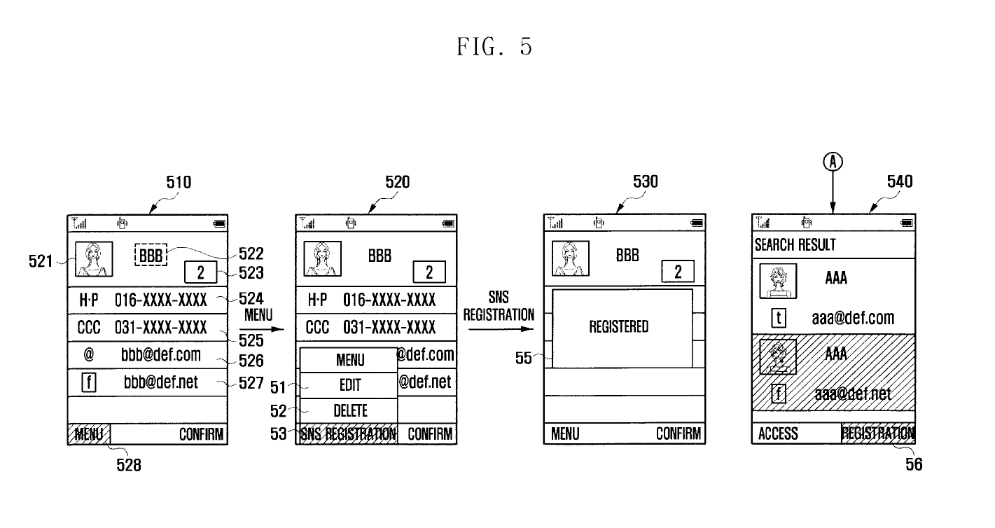

The display unit 130 displays information inputted by user and information which is provided to the user in addition to various menus of the mobile terminal 100. The display unit 130 can provide various screens according to the use of mobile terminal 100, for example, a stand-by screen, a message writing screen, a call screen, or the like. Moreover, the display unit 130 can display screens such as: a phone book displaying a contact address stored in the storage unit 120, a screen that shows sending phone book data to other mobile terminal, a screen that shows receiving phone book data which other mobile terminal sends, a screen that shows searching SNS information using at least one among selected name of a recipient party, e-mail address, phone number, or the like. A detailed description will be further described in conjunction with exemplary screens shown in FIGS. 4 to 5. The display unit 130 can also include a liquid crystal display (LCD), an organic light emitted diode (OLED), and an active matrix organic light emitted diode (AMOLED). When the display unit 130 comprises a touch screen, the display unit 130 can function as an input unit 140, and the input unit can be an auxiliary input unit.

The wireless communication unit 150 can form a communication channel (including voice communication and image communication) for call connection with the base station and a communication channel for data transmission. For example, the wireless communication unit 150 may transmit voice signals and/or image signals to the recipient party's terminal or receive a voice signal and an image signal from the recipient party's terminal through the communication channel under the control of the controller 110. The wireless communication unit 150 can include a radio frequency transmission unit (not shown) for up-converting and amplifying a frequency of a transmission signal, a radio frequency reception unit (not shown) for low-noise amplifying and down-converting a frequency of a received signal, and a transmitter/receiver separator (not shown) for separating the transmission signal and the received signal. In particular, the wireless communication unit 150 according to the present invention can preferably transmit and receive a SNS message to/from a web server which provides SNS. The wireless communication unit 150 can transmit a request signal for information registration of the recipient party to the web server which provides SNS. The wireless communication unit 150 can request a search for SNS information of recipient party to the web server under the control of controller 110. To this end, the wireless communication unit 150 can transmit at least one among the name of recipient party, the phone number and e-mail to the web server. When the SNS information search is requested, the wireless communication unit 150 can transmit the request signal for searching SNS information to a plurality of web servers which provide SNS. The wireless communication unit 150 can receive the SNS information of the recipient party searched by a plurality of web servers.

With continued reference to FIG. 1, near field communication unit 160 can transmit or receive a wireless signal after forming a communication channel with other mobile terminals which exist within a given range under the control of controller 110. In particular, the near field communication unit 160 according to the present invention preferably sends all or some of phone book data (address book) to another mobile terminal, or receives phone book data from another mobile terminal according to a user's request. The near field communication unit 160 can use a near field communication method including but in no way limited to Bluetooth, infrared communication and Zigbee or the like.

The storage unit 120, which is a non-transitory storage medium, can store a program which is necessary for functional operations of the present invention, as well as user's data, or the like. The storage unit 120 can roughly include a program area and a data area. The program area preferably stores a control program for overall operation of the mobile terminal 100, an operation system (OS) for booting the mobile terminal 100, an application program for playing multimedia contents, an application program for providing optional features of mobile terminal such as camera function, sound playing function, an image or a video function, and an application program which is required for near field communication. In particular, the program area preferably stores a program extracting the searching information (e.g., the phone number, name, e-mail, or the like) for the SNS information search from phone book data.

The data area of the storage unit comprises an area in which data generated by the use of the mobile terminal 100 is stored, which can store a phone book 20, audio data and information corresponding to pertinent contents or user data. Particularly, the data area of the present invention can store at least one web server address which provides the SNS. The web server address is used when SNS information is requested using the search information. The phone book 20 can store at least one contact address information, i.e., the phone number, the e-mail address, image, or the like. To this end, the phone book 20 can include a name input field, a phone number input field, an e-mail input field, and an image input field. In particular, the phone book 20 according to present invention can include at least one SNS input field for inputting SNS information.

The controller 110, which may comprise a processor or microprocessor, can control the overall operation and signal flows between internal blocks of mobile terminal 100. In particular, the controller 110 according to the present invention can preferably control automatic registration of SNS information using phone book data. In detail, the controller 110 can receive and store phone book data through the near field communication, wireless Internet, wire cable, and user's input. At this time, the controller 110 can check whether or not the phone book data includes at least one SNS information. When at least one SNS information is included in the phone book data, the controller 110 controls to register the SNS information included in the phone book to user's SNS address. To this end, the controller 110 can send at least one SNS information to the web server which provides corresponding SNS.

Meanwhile, when the phone book data does not include the SNS information, the controller 110 controls to extract searching information for searching the SNS information from the phone book data, transmitting the extracted searching information to at least one web server and requesting the search of the SNS information of the recipient party corresponding to the phone book data, receiving the search result from the at least one web server, and displaying the received search result.

Next, the controller 110 can control the registration of at least one selected SNS information from among the result to the user's SNS address book. The search information can include at least one among name, e-mail, phone number which are included in the phone book data.

Meanwhile, although not shown in FIG. 1, the mobile terminal 100 according to the present invention may selectively further include other elements to achieve additional functions, e.g., a camera module for capturing a still image or video, a broadcast receiving module for receiving broadcast data, a digital sound playing module like an MP3 module, and a proximity sensor module for proximity sensing, just to name a few possible additional elements.

Those elements of the mobile terminal 100 can vary according to the convergence trend of digital devices, and thus, cannot be enumerated. However, the mobile terminal 100 according to the present invention may further include elements equivalent to the level of foregoing structural elements.

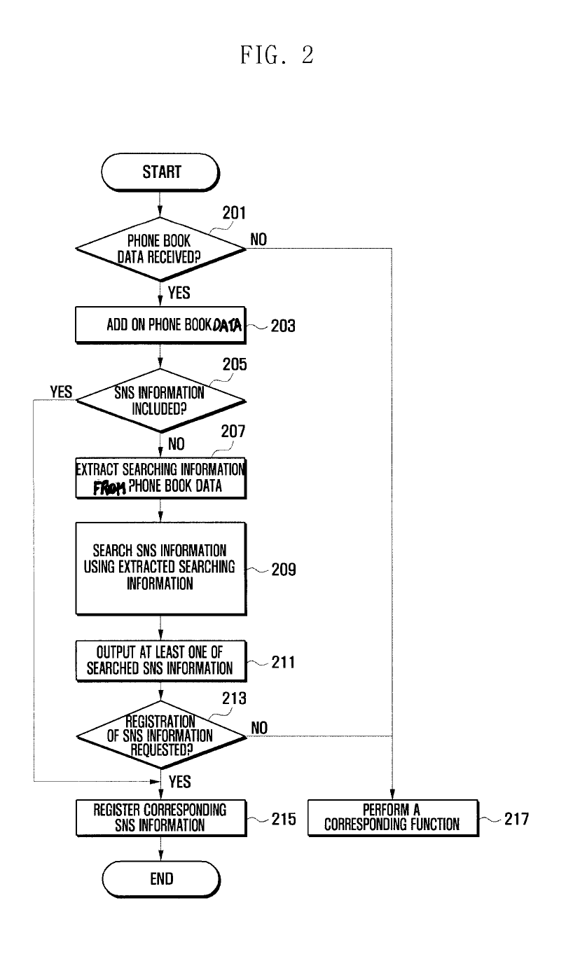

FIG. 2 is a flowchart illustrating exemplary operation of a method of registering SNS information using a phone book data (address book) transmission function according to a first exemplary embodiment of the present invention.

Referring now to FIGS. 1 and 2, at (201) the controller 110 of the mobile terminal 100 according to a first exemplary embodiment of the present invention checks whether at least one phone book data (address book) is received. The phone book data can be received, for example, from another mobile terminal which has an address book transmission function using near field communication via near field communication unit 160. Alternatively, phone book data can be received through the wireless communication unit 150 or from a wire or cable coupled to an interface of the device.

If at (201) the phone book data is not received, the method proceeds to (217) and the controller 110 performs a pertinent function. For example, the controller 110 can maintain a standby state, or can perform a music playing function, a broadcasting receiving function and/or a text message writing function in response to the request of user, just to name a few possibilities.

On the other hand, when phone book data is received at (201), then at (203) controller 110 can add at least one received phone book data to the phone book 20 of the storage unit 120.

Next, at (205) the controller 110 can check whether or not SNS information is included in the at least one received phone book data.

When SNS information is included, the controller 110 proceeds to step 215 which will be described later and can register the corresponding SNS information. For the registration of the SNS information, the controller 110 can transmit corresponding SNS information to pertinent web server through the wireless communication unit 150.

Meanwhile at (207), when the SNS information is not included, the controller 110 can extract at least one search information (e.g., at least one among name, e-mail, phone number).

At (209) the controller 110 can search the SNS information of recipient party corresponding to the phone book data which is received using extracted search information.

In detail, the controller 110 can request SNS information search of the recipient party by transmitting the extracted search information to the at least one web server which provides SNS through the wireless communication unit 150. Next, the controller 110 can receive search result from the web server. To this end, user or mobile terminal manufacturer can previously store at least one web server address to request the SNS information search in the storage unit 120. When the SNS information search is completed, then at (211) the controller 110 can display at least one searched SNS information of the recipient party on the display unit 130.

At (213), the controller can check whether or not the SNS information registration is requested. More particularly, the controller 110 can check whether the user selects at least one SNS information and requests the registration of the SNS information.

When the SNS information registration is not requested, then at (217) the controller 110 can operate corresponding function.

For example, the controller 110 can connect the selected SNS according to user's request and check whether it is correct SNS information of the recipient party that the user wants.

On the other hand, when the registration of the SNS information is requested, then at (215) the controller can register the SNS information which is requested to register.

Meanwhile, the method proceeds to (207) in the case where at (205) the phone book data does not include any SNS information, but the prevent invention is not limited thereto. For example, the present invention can further include a step of checking whether the SNS information is searched between step 205 and step 207. Similarly, it is illustrated that it proceeds to step 215 in case the received phone book data includes SNS information at step 205, but a step of checking whether the SNS information included in the phone book data is registered can be further included.

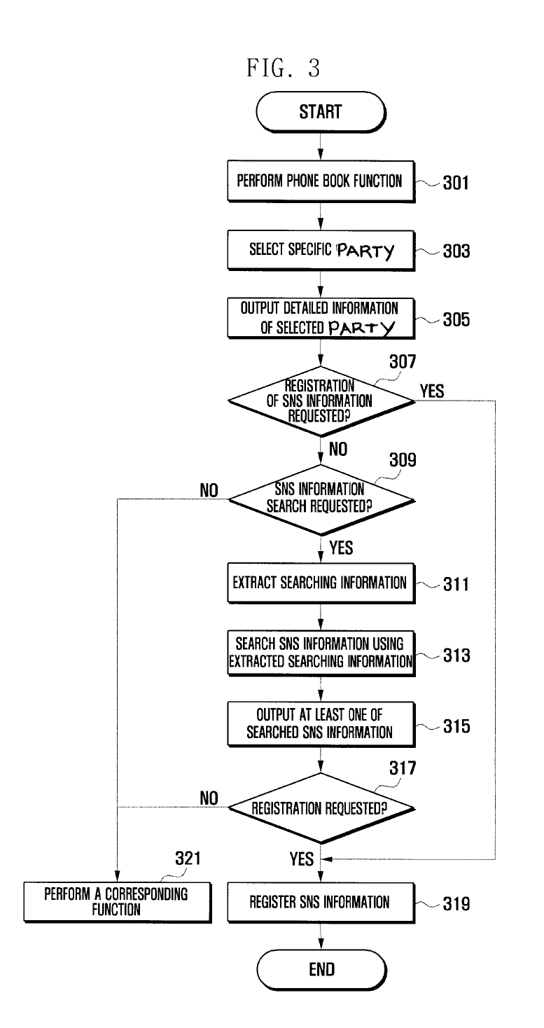

FIG. 3 is a flowchart illustrating a method of registering SNS information using a phone book according to a second exemplary embodiment of the present invention, and FIGS. 4 to 5 are example screens for explaining a second exemplary embodiment of the present invention.

Referring now to FIG. 1, and FIG. 3 to FIG. 5, at (301) the controller 110 according to a second exemplary embodiment of the present invention operates a phone book function according to user's request. When the phone book function is operated, the controller 110 can output a phone book screen like the screen of reference numeral 410 in FIG. 4.

With reference to FIG. 4, the phone book screen preferably includes an indicator area (1) which outputs an image indicating an antenna received signal strength, battery, and a bell sound output mode, a search area (2) for the search of phone book list, a list area (3) which outputs stored phone book information according to a given rule (e.g., the lexicographic order) and a menu area (4).

Next at (303), when user selects a specific opponent (“recipient party”) by choosing one of phone book information outputted from the list area, then at (305) controller 110 can output detailed information of the selected recipient party.

For example, if user selects one item from among a plurality of phone book lists like the screen of reference numeral 410, the detailed information about the selected recipient party can be outputted like the screen of reference numeral 420 or the screen of reference numeral 510 in FIG. 5.

Here, referring now to the screens of reference numeral 420 and reference numeral 510 shown in FIGS. 4 and 5, the detailed information can include at least one among a photo image 421 or other type of image, 521, a name or identifier 422, 522, an abbreviated number 423, 523, a mobile phone number 424, 524, a home telephone number 425, 525, an e-mail address 426, 526 and SNS information 527. At this time, referring to the screen of reference numeral 420, it can be known that an item “AAA” does not include any SNS information. Referring now to the screen of reference numeral 510, it can be known that an item “BBB” includes SNS information.

Next, with regard to (307) in FIG. 3, the controller 110 can check whether the registration of SNS information is requested.

When at (307) the registration of SNS information is not requested, then at (309) the controller 110 can check whether the search of SNS information is requested.

More specifically, the controller 110 can check whether or not the user selects a SNS search 43 menu from among sub-menus for output(edit 41, delete 42 and SNS search 43) like the screen of reference numeral 430, after activating a menu 428 in the state where the SNS information is not included in detailed information like the screen of reference numeral 420.

If user does not select the SNS search 43 menu, then at (321) the controller 110 can perform a pertinent function. For example, the delete 42 menu is selected, the controller 110 can delete the item “AAA” in the phone book. Alternatively, when the edit 41 menu is selected, the phone number, the e-mail address or the like can be modified according to an input signal, or the SNS information can be manually input.

On the other hand, when user selects the SNS search 43 menu, then at (311) controller 110 extracts part of SNS search information (e.g., at least one information among a name, an e-mail and a phone number) among detailed information of item “AAA”, and at (313) searches SNS information of item “AAA” using extracted searching information.

More specifically, the controller 110 can request SNS information search of item “AAA” to the web server, by transmitting the extracted searching information to the at least one web server which provides SNS through wireless communication unit 150. At this time, the controller 110 can output a pop-up window 45 which informs that it is searching SNS information of the item “AAA” like the screen of reference numeral 440.

Next at (315), if the search result is received from the web server, the controller 110 can display at least one SNS information of the item “AAA” on the display unit 130. For example, the controller 110 can output search result like the screen of reference numeral 540.

Referring to the screen 540 shown in FIG. 5, it is shown that a user corresponding to item “AAA” uses two SNSs. Also, the SNS ID being used in each SNS can be shown. Meanwhile, in case the search result does not exist, the controller 110 can output a pop-up window which informs that searched SNS information does not exist.

At (317), the controller 110 can check whether the registration of SNS information is requested. That is, the controller 110 can check whether user executes a registration menu 56 after selecting at least one SNS information like the screen of reference numeral 540.

If at (317) the registration of the SNS information is not requested, then at (321) the controller 110 can perform a pertinent function. For example, the controller 110 can connect to the selected SNS according to user's request, and can check whether it is correct SNS information of the recipient party that the user wants.

On the other hand, if the registration of the SNS information is requested, then at (319) the controller 110 can register the SNS information which is requested to register. Meanwhile, when at (307) the registration of the SNS information is requested, the controller 110 can register SNS information.

Concretely, the controller 110 can check whether user selects a SNS registration 53 menu among sub-menus slid to be outputted (edit 51, delete 52 and SNS search 53) like the screen of reference numeral 520, after activating a menu 528 in the state where the SNS information is included in detailed information like the screen of reference numeral 510. If user selects the SNS registration 53 menu, the controller 110 registers the SNS information, and can output a pop-up window 55 which informs that the registration of the SNS information is finished like the screen of reference numeral 530. As illustrated in FIG. 2, the controller 110 can transmit pertinent SNS information to a corresponding web server through the wireless communication unit 150 for the registration of the SNS information.

In accordance with some of the examples shown and described herein, the present invention can input SNS information in the phone book data, checks the phone book data, and, in case the phone book data includes at least one SNS information, automatically registers the at least one SNS information included in the phone book data into user's SNS address book, and, in case the phone book data does not include any SNS information, searches and registers the SNS information of the recipient party using another information included in the phone book as searching information. Therefore, the present invention links the phone book function with the SNS function, so that the SNS information of the recipient party can be easily registered. Also, the present invention can search the SNS information of the recipient party by using the information like the name, the phone number and e-mail stored in the phone book. That is, even though user does not access to the web server providing SNS, user can search and register the SNS information of the recipient party. Accordingly, the present invention can improve the convenience of user when using the SNS through the mobile terminal.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of registering Social Network Service (SNS) information, the method comprising:
checking a phone book by a controller to determine whether or not phone book data includes at least one SNS information; and
registering the at least one SNS information from the phone book in an SNS address book of a user, when the phone book data includes the at least one SNS information.

2. The method of claim 1, wherein the controller automatically registers in the SNS address book the at least one SNS information from the phone book data.

3. The method according to claim 1, wherein when the phone book data does not include the SNS information, a previously stored at least one web server address is retrieved to request the SNS information from at least one web server associated with a respective web server address.

4. The method according to claim 1, wherein the phone book data is transmitted by a wireless communication unit using a transmission protocol other than near field communication.

5. The method of claim 1, further comprising:
extracting by the controller searching information from the phone book data to search for SNS information when the phone book data does not include the SNS service information; searching SNS information of a recipient party corresponding to the phone book data using the extracted searching information; and
registering at least one SNS information selected from among the searched SNS service information of recipient party in the SNS address book of user.

6. The method of claim 5, wherein searching SNS information of the recipient party comprises:
requesting a search of the SNS information of the recipient party by transmitting the extracted searching information to at least one preset web server; and
receiving a search result from the at least one web server.

7. The method of claim 6, further comprising displaying the received search result.

8. The method of claim 5, wherein the searching information comprises at least one of a name, an e-mail and a phone number.

9. The method of claim 1, wherein registering the at least one SNS information further comprises: transmitting the at least one SNS information to a web server which provides a corresponding SNS.

10. The method of claim 1, further comprising receiving the phone book data through a near field communication.

11. An apparatus for registering Social Network Service (SNS) information, the apparatus comprising:
a storage unit configured to store at least one phone book data; and
a controller configured to check whether the phone book data includes at least one SNS information, and to register at least one SNS information in an SNS address book of a user when the phone book data includes the at least one SNS information.

12. The apparatus of claim 11, wherein, in case the phone book data does not include SNS information,
the controller is configured to extract searching information to search SNS information from the phone book data, request a search of SNS information of a recipient party corresponding to the phone book data by transmitting the extracted searching information to at least preset one web server, receive a search result from the at least one web server, and display the received search result.

13. The apparatus of claim 12, wherein the controller is configured to register at least one SNS information selected from among the displayed search result into the SNS address book of a user.

14. The apparatus of claim 12, wherein the searching information includes at least one of a name, an e-mail and a phone number.

15. The apparatus of claim 11, further comprising a near field communication unit which receives phone book data from another mobile terminal,
wherein the controller is configured to check whether or not the phone book data received through the near field communication unit includes at least one SNS information, and register the SNS information included in the phone book data into the SNS address book of a user when the phone book data includes at least one SNS information.

16. The apparatus of 11, wherein the controller is configured to register the at least one SNS information into the SNS address book of a user by transmitting the at least one SNS information to a web server which provides a corresponding SNS.

17. The apparatus of claim 12, comprising a mobile communication terminal including the controller, storage unit, a near field communication unit and a wireless communication unit, wherein the wireless communication unit uses a protocol other than near field communication to communicate with a base station.

18. The apparatus of claim 12, wherein a display unit displays the received search result, and wherein the display unit comprises a touch screen.

19. The apparatus according to claim 17, wherein the wireless communication unit transmits via a spread spectrum communication system.
